(19) United States
(12) Patent Application Publication
(10) Pub. No.: US 2014/0145645 A1
(43) Pub. Date: May 29, 2014

(54) STEP-DIMMING LED DRIVER AND SYSTEM

(71) Applicant: GENERAL ELECTRIC COMPANY, Schenectady, NY (US)

(72) Inventor: Gang Yao, Cleveland, OH (US)

(73) Assignee: GENERAL ELECTRIC COMPANY, Schenectady, NY (US)

(21) Appl. No.: 13/685,740

(22) Filed: Nov. 27, 2012

(51) Int. Cl. H05B 37/02

(52) U.S. Cl. CPC H05B 37/02
USPC 315/307; 315/291

(57) ABSTRACT

A dimming control circuit for an LED module includes an LED driver configured to provide an output voltage that is used to drive the LED module, a voltage divider coupled to the output voltage, and a dimming control module coupled to the voltage divider. The dimming control module configured to change a resistance of the voltage divider to reduce the output voltage from the LED driver and dim the LED module.

### BACKGROUND

1. Field of the Invention

The aspects of the present disclosure relate generally to driver circuits for light emitting diode devices and in particular to dimming driver circuits for light emitting diode devices and arrays.

2. Description of Related Art

Light Emitting Diodes (LED) are widely used in general lighting. An LED is generally understood as a semiconductor device that generates light when electrical energy is applied to the device. LED arrays, in which multiple LEDs are formed into an array and powered as a unit, are gaining popularity in lighting and signaling applications. LED arrays are typically connected to a direct current (DC) power source where the amount of applied current controls the brightness of emitted light.

LEDs are voltage sensitive devices. An LED must be supplied with a voltage that is above a threshold voltage and a current that is below the rating of the particular LED device. Generally, the current that is supplied to an LED is dependent exponentially on the voltage, referring to the Shockley diode equation. A small change in voltage can cause a large change in current. If the maximum voltage rating is exceeded by a small amount, the current rating can be exceeded by a large amount, potentially damaging the LED.

An LED driver or driving circuit is a type of power conversion circuit that delivers constant current instead of constant voltage. The typical LED driving circuit, or driver device, will convert a line voltage alternating current (“VAC”) to a direct current (“DC”). Some LED systems have two sub-systems. The first or upstream sub-system is generally a stand-alone constant voltage LED driver. The second or downstream sub-system is the LED module, which has one or more of an internal ballast resistor, linear regulator or switched power supply, to convert the DC voltage to DC current. The downstream LED module will typically include a low voltage protection circuit. The low voltage protection circuit will lower the power delivered to drive the LED when the input voltage is below a predetermined input voltage threshold level.

High powered LEDs (HPLED) can be driven at currents that range from hundreds of milliamperes to more than an ampere and emit over one thousand lumens. Low powered LEDs are driven at currents that are in the tens of milliamperes. The basic driver types for high power LEDs include constant current drivers and constant voltage/wattage type drivers.

A constant current LED driver will provide a constant current (amperage) to the LED(s). The output voltage from such an LED driver will vary depending upon the load. A constant current LED drive will maximize the energy efficiency with less loss. However, the fixed LED current load within the driver output current limits the flexibility of the design. The constant current LED driver is typically used in applications with a fixed number of LEDs.

A constant output voltage/wattage type of LED driver will provide a constant voltage to the LED(s). The wattage will remain constant with variations in the load. Because the voltage is constant, the constant voltage type of driver finds particular application where the types and numbers of LEDs vary.

LED dimming solutions generally include constant current reduction (“CCR”) or pulse-wave modulation dimming (“PWM”). Constant current dimming generally involves linear adjustment of the current through the LEDs. Pulse-wave modulation will drive the LEDs at one current level, but will turn the LEDs on or off at a frequency that is generally greater than 120 Hz. However, pulse wave modulation can have some drawbacks. For example, the costs associated with pulse-wave modulation solutions can be expensive. Also, pulse-wave modulation can generate in-rush currents, which can negatively affect the LED, such as by shorting the LED rated life, as well as generating electromagnetic interference (EMI).

Some pulse-wave modulation dimming solutions will also use a field effect transistor (FET) in series with the LED lamp to pulse-wave modulate the lamp current when dimming is desired. However, this type of approach can be subject to losses in the FET.

Accordingly, it would be desirable to provide a dimming LED driver circuit that resolves at least some of the problems identified above.

### SUMMARY OF THE INVENTION

As described herein, the exemplary embodiments overcome one or more of the above or other disadvantages known in the art.

One aspect of the present disclosure relates to a dimming control circuit for an LED module. In one embodiment, the dimming control circuit includes an LED driver configured to provide an output voltage that is used to drive the LED module, a voltage divider coupled to the output voltage, and a dimming control module coupled to the voltage divider. The dimming control module is configured to change a resistance of the voltage divider to reduce the output voltage from the LED driver and dim the LED module.

Another aspect of the disclosed embodiments is directed to a step-dimming LED lighting system. In one embodiment, the step-dimming LED lighting system includes an LED driver configured to provide a constant voltage output, an LED module driven by the LED driver, and a voltage divider. The voltage divider is configured to control the constant voltage output of the LED driver between a high output state and a low output state, wherein in the high output state the LED module operates at a full power condition, and in a low output state the LED module operates at a low power condition.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates a block diagram of an exemplary dimming LED driver circuit incorporating aspects of the present disclosure.

FIG. 2 illustrates a graph of the voltage output of one embodiment of the dimming LED driver circuit shown in FIG. 1.

FIG. 3 illustrates a block diagram of an exemplary LED lighting system incorporating a dimming LED driver incorporating aspects of the present disclosure.

### DETAILED DESCRIPTION OF THE DISCLOSED EMBODIMENTS

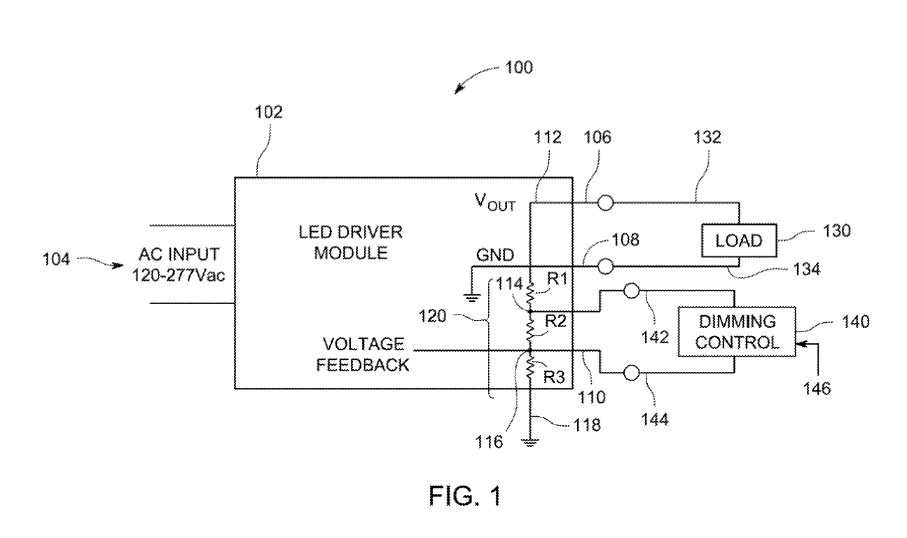

Referring to FIG. 1, one embodiment of a dimming LED driver circuit incorporating aspects of the disclosed embodiments is generally indicated by reference number 100. The aspects of the disclosed embodiments provide an LED lighting dimming solution that does not involve pulse width modulation. Rather, the aspects of the disclosed embodiments implement a low cost solution that changes a voltage output of the LED driver 102 to provide the dimming function. In one embodiment, the aspects of the disclosed embodiments provide two output levels for the LED driver 102 that is configured to drive the LED module or load 130. At a full load condition where dimming is not desired, the output voltage or level is high. When dimming is desired, the output voltage or level is low. A low level can be any suitable level that is less than the high level. Generally, the voltage outputs are substantially constant voltage output levels. A voltage divider 120 is provided as part of, or coupled to the LED driver module 102. The voltage divider 120 is generally configured to adjust the output voltage of the LED driver 102 to provide the full output voltage of the LED driver 102 when dimming is not desired and a reduced output voltage when dimming is desired. A dimming control signal 146 is used to vary the output of the LED driver 102. In one embodiment, the dimming control signal 146 will reduce the resistance of the voltage divider 120, such as by for example, electrically shorting a resistor R2 in the voltage divider 120. The shorting of the resistor R2 changes the resistance of the voltage divider 120, which changes the output voltage. The dimming LED driver circuit 100 of the disclosed embodiments provides a cost effective step dimming solution that provides higher efficiency than a pulse wave modulation dimming solution.

As is shown in FIG. 1, the LED driver 102 receives an alternating current (AC) voltage input 104 and generates a direct current (DC) voltage output on output voltage line 106. In the embodiments described herein, the LED driver 102 is a constant voltage type of LED driver. The output voltage on output voltage line 106 is used to drive the load 130. As will be understood, the output voltage will be converted to a current required to drive the LEDs that make up the load 130. In one embodiment, the load 130 generally comprises one or more LEDs, or LED arrays, and can include or be coupled to a suitable ballast resistor, linear regulator or switching power supply to convert the DC output voltage received on input line 132 to the constant current required for the LED(s) that make up the load 130. The return 134 of the load 130 is electrically coupled to the ground connection 108 of the LED driver 102.

The AC voltage input 104 is any suitable AC mains input, such as for example 120-277 VAC, 50/60 Hz, as is generally understood. In the embodiment shown in FIG. 1, the LED driver 102 generally comprises a 24 volt LED driver. As will be understood, the LED driver 102 can include or be coupled to suitable AC power rectification and conversion, to convert the AC voltage input on input lines 104 into a constant DC voltage output on output voltage line 106. In the embodiments described herein, the LED driver 102 does not include or deliver a pulse wave modulated output signal to modulate the visible output of the load 130. Furthermore, unlike prior art designs, the dimming circuit 100 of the disclosed embodiments does not include or require a switch at the output to regulate the output voltage to control the dimming.

In one embodiment, the LED driver 102 includes a voltage divider, generally indicated by reference 120. The voltage divider 120, also referred to as a resistor divider, generally comprises a series resistance. In one embodiment the series resistance comprises one or more resistors. In the embodiment shown in FIG. 1, three resistors R1, R2 and R3 as shown. As is shown in FIG. 1, the resistors R1, R2 and R3 are electrically coupled to one another in a series connection, between node 112 and node 116 of the LED driver 102. In the embodiment shown in FIG. 1, the voltage divider 120 is internal to the LED driver 102. In alternate embodiments, the voltage divider 120 can be suitably arranged in relation to the LED driver 102 to provide the functionality described herein. For example, in one embodiment, the voltage divider 120 can comprise a module that is external to the LED driver 102.

As is illustrated in the example of FIG. 1, in one embodiment, the node 112 is electrically coupled to the output voltage line 106. The node 118 is electrically connected to electrical ground. In one embodiment, one side of the first resistor R1 is coupled to node 112, while the other side of R1 is coupled to one side of the second resistor R2. The other side of R2 is coupled to the third resistor R3 at node 116. Node 116 is electrically coupled to a voltage feedback line 110 of the LED driver 102. While three resistors are shown in the embodiment of FIG. 1, in alternate embodiments, any suitable number of resistors can be utilized.

As shown in FIG. 1, a dimming control module 140 is coupled to nodes 114 and 116 of the voltage divider 120. The dimming control module 140 is configured to receive a dimming control signal 146 that is configured to enable the dimming control module 140 to reduce the resistance of the voltage divider 120 and reduce the output voltage of the LED driver 102 on out voltage line 106. The dimming control module 140 is configured to change the voltage output from the LED driver 102 on output line 106 from a high state to a low state.

In the exemplary embodiment described with respect to FIG. 1, the high state is a voltage of approximately 24 volts DC, while the low state is a voltage of approximately 12 volts DC. When the dimming control signal 146 is indicative of a high output voltage state and the LED driver 102 is a 24 VDC LED driver, the dimming control module 140 will enable the voltage divider 120 to provide a voltage on output line 106 of approximately 24 volts, where the LED driver 102 is a 24 volt driver. When the dimming control signal 146 is indicative of a low output voltage state, the dimming control module 140 will enable the voltage divider 120 to provide a voltage on output line 106 that is less than 24 volts, such as for example 12 volts. In one embodiment, the dimming control signal 146 is configured to enable the dimming control module 140 to change a resistance of the voltage divider to reduce the voltage on the output voltage line from 24 volts to a lower voltage such as 12 volts. While the embodiments described herein generally refer to a low output voltage state that is approximately one-half of the high output voltage state, in alternate embodiments, the low output voltage state can be any suitable output voltage other than and including one-half of the high output voltage state. For example, the low output voltage state could be approximately one-third of the high output voltage state.

As shown in FIG. 1, the dimming control module 140 includes dimming control leads 142, 144. The dimming control leads 142, 144 are coupled to nodes 114, 116 of the voltage divider 120. In the example of FIG. 1, the nodes 114, 116 are coupled to each end of resistor R2. When the dimming control signal 146 is indicative of a low output voltage state, the dimming control module 140 is configured to cause dimming control leads 142 and 144 to electrically short or shunt resistor R2. In this situation, the series combination of resistors R1 and R3 in the voltage divider 120 is configured to reduce the output voltage on output voltage line 106 to the low voltage state. In one embodiment, the low voltage state, or the voltage provided to the LED module 130 when resistor R2 is electrically shorted, is reduced to approximately 12 volts. When the voltage on input line 132 to the load 130 drops to approximately 12 volts, the load 130, which generally includes internal low voltage protection and current limiting, will operate at low power, thus dimming the LED(s) in the load 130.

In the embodiment shown in FIG. 1, the values of resistors R1, R2 and R3 of the voltage divider 120 are generally selected to provide a voltage on output voltage line 106 of approximately 24 volts in the high output voltage state and approximately 12 volts in the low output voltage state. In one embodiment, the resistors in the voltage divider 120 can have approximate values such as R1=39 kΩ; R2=47 kΩ; and R3=10 kΩ. In alternate embodiments, the values of resistors R1, R2 and R3 in the voltage divider 120 can be any suitable values that achieve the high and low state functionality described herein.

In one embodiment, the dimming control module 140 comprises a switching device, such as a switch or a relay. The switching device can be controlled manually, such as by a user, or automatically, such as a by a program, sensor or timer that is configured to determine periods when the load 130 should be dimmed. For example, in one embodiment, the dimming control module 140 comprises or is coupled to an occupancy sensor application or device. When the dimming control module 140 is coupled to an occupancy sensor, the dimming control signal 146 can be received from the occupancy sensor. An occupancy sensor application can include a relay or switch to provide a dimming control signal 146 that will cause the dimming control module 140 to short or open the dimming control leads 142, 144 based on a detected occupancy of an area, such as a room. For example, when a monitored area is determined to be occupied, the occupancy sensor can generate a dimming control signal 146 that will enable the dimming control module 140 to maintain the dimming control leads 142, 144 in an electrically open state, resulting in the full voltage output from the LED driver 102. When a non-occupied state is detected, the occupancy sensor can enable the dimming control module 140 to cause control leads 142, 144 to electrically short resistor R2 in the voltage divider 120 of the LED driver 102, thus reducing the constant voltage output of the LED driver 102. Although the aspects of the disclosed embodiments are generally described herein with respect to the dimming control signal 146 be provided by a device external to the dimming control module 140, in one embodiment, the dimming control module 140 can generate the dimming control signal 146. For example, in one embodiment, the dimming control module 140 comprises an occupancy sensor device or such other device that is used to control the LED driver 102 to dim the LED load 130. In this example, dimming control module 140 internally generates the dimming control signal 146 that enable the dimming control module 140 to electrically short the dimming control leads 142, 144 across resistor R2. Although the aspects of the present disclosure are generally described with respect to electrically shorting resistor R2, in alternate embodiments, any one or more of the resistors in the voltage divider 120 can be electrically shorted to switch between a high output state and a low output state.

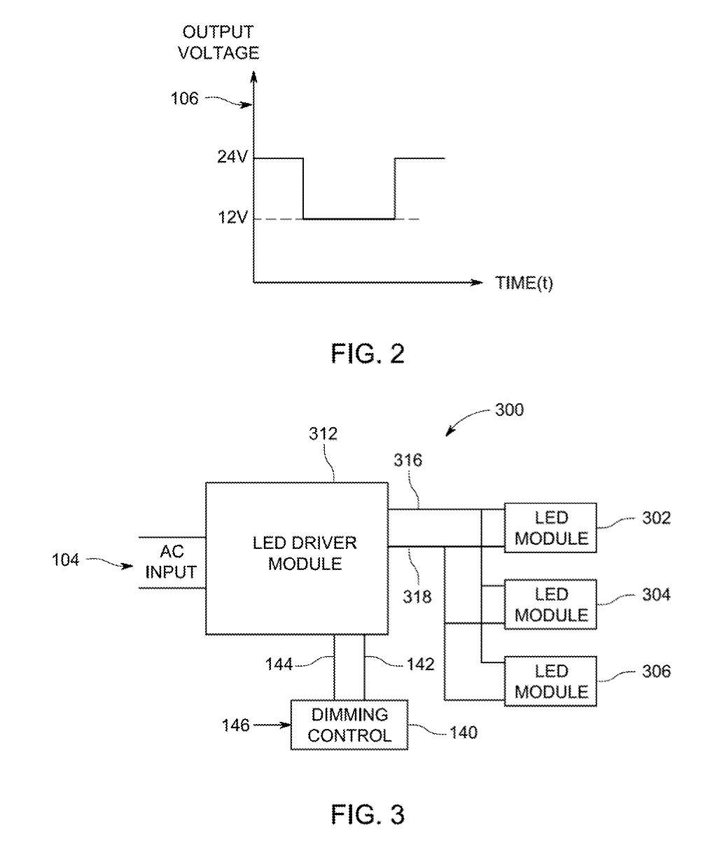

FIG. 2 is a graphical illustration of the voltage state on output voltage line 106 versus time (t) in accordance with aspects of the disclosed embodiments. As is shown in FIG. 2, when the dimming control signal 146 is indicative of a high output voltage state, and the dimming control module 140 does not cause dimming control leads 142, 144 to electrically short resistor R2 of FIG. 1, and the voltage on output voltage line 106 is approximately 24 V. When the dimming control signal 146 is indicative of a dimmed or low output voltage state, and the dimming control module 140 enables the dimming control leads 142, 144 to electrically short resistor R2 and the output voltage on output voltage line 106 drops to approximately 12 V. As shown in FIG. 2, the output voltage, as it appears on output voltage line 106 of FIG. 1, is substantially constant in each of the high and low states.

FIG. 3 illustrates one embodiment of a system 300 in which the aspects of the present disclosure can be practiced. In this example, the LED driver 102 is used to drive LED modules 302, 304 and 306. The LED modules 302, 304 and 306 can comprise any suitable type of LED application or device. While only three LED modules are illustrated in FIG. 3, in alternate embodiments the system 300 can include any suitable number of LED modules. Each LED module 302, 304 and 306 will include or be coupled to a suitable power supply to convert the DC voltage to the constant current required to drive the LED module, such as a linear power supply or a switching power supply. Each LED module 302, 304 and 306 will also include its own low voltage protection circuit. The dimming control signal 146 will enable the dimming control module 140 to provide a high or low output voltage state signal on dimming control lines 142, 144. The output of the LED driver 312 in this example, on output voltage line 316 will be controlled to provide a high state output voltage or a low state output voltage. Line 318 is the return line from each module 302, 304, 308 to the LED driver 312. Each of the LED modules 302, 304, 306 is configured to detect the voltage on the output voltage line 106 and produce a constant current corresponding to the particular state.

The aspects of the disclosed embodiments are directed to a dimming LED driver circuit 100 that changes an output of the LED driver 102 between two voltage output levels to realize dimming of the LED 130, while not utilizing pulse wave modulation dimming and can be applied in any LED system where a LED lighting dimming solution is desired. For example, in one embodiment, one or more of the LED modules 302, 304 or 306 can comprise a display or signage lighting application. As another example, in store refrigerator display lighting applications, dimming is used when there is no activity near the display. For example, one type of commercial refrigerator includes an LED bar/module that is located inside the refrigerator. When a customer is in proximity to the refrigerator, the LED bar/module is configured to operate at full power, corresponding to the high state described herein. When no one is in proximity to the refrigerator, meaning the occupancy sensor does not detect a presence, the LED bar/module can be dimmed. In accordance with the aspects of the disclosed embodiments, the LED Driver 102 will be commanded by the dimming control signal 146 to reduce the voltage output of the LED driver 102, which will result in the LED bar/module reducing the current delivered to the LEDs, thus dimming the LED bar/module.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit and scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A dimming control circuit for an LED module, comprising:
an LED driver configured to provide an output voltage that is used to drive the LED module;
a voltage divider coupled to the output voltage; and
a dimming control module coupled to the voltage divider, the dimming control module configured to change a resistance of the voltage divider to reduce the output voltage and dim the LED module.

2. The dimming control circuit of claim 1, wherein the output voltage is a constant voltage output.

3. The dimming control circuit of claim 1, wherein the voltage divider coupled to the output voltage of the LED driver is configured to control a switching of the output voltage between a high output voltage state and a low output voltage state.

4. The dimming control circuit of claim 3, wherein the voltage divider is integrated within the LED driver.

5. The dimming control circuit of claim 3, wherein the voltage divider comprises a set of series coupled resistors, and the dimming control module is configured to electrically short a resistor in the set of series coupled resistors to switch the output voltage to the low output voltage state.

6. The dimming control circuit of claim 5, wherein the set of series coupled resistors comprises a first resistor, a second resistor and a third resistor, the second resistor being coupled between the first and third resistors, and wherein the dimming control module is electrically coupled to the second resistor and configured to electrically short the second resistor to reduce the output voltage to the low output voltage state.

7. The dimming control circuit of claim 1, wherein the output voltage from the LED driver is reduced by approximately one-half in the low output voltage state.

8. The dimming control circuit of claim 1, wherein the dimming control module is a switching device.

9. The dimming control circuit of claim 1, wherein the dimming control module is an occupancy sensor.

10. A step-dimming LED lighting system, comprising:
an LED driver configured to provide a constant voltage output;
an LED module driven by the LED driver; and
a voltage divider, the voltage divider configured to control the constant voltage output of the LED driver between a high output state and a low output state, wherein in the high output state the LED module operates at a full power condition and in a low output state, the LED module operates at a low power condition.

11. The step-dimming LED lighting system of claim 10, comprising:
a dimming control module coupled to the LED driver, the dimming control module configured to provide a dimming control signal to control the constant output voltage between the high output state and the low output state.

12. The step-dimming LED lighting system of claim 11, wherein the dimming control module comprises a switching device.

13. The step-dimming LED lighting system of claim 11, wherein the dimming control module is an occupancy sensor.

14. The step-dimming LED lighting system of claim 11, wherein the voltage divider comprises a series coupled resistance and the dimming control signal is configured to reduce a resistance value of the series coupled resistance to cause the LED driver to provide the low voltage output.

15. The step-dimming LED lighting system of claim 14, wherein the series coupled resistance is electrically coupled between an output voltage line of the LED driver and an electrical ground.

16. The step-dimming LED lighting system of claim 14, wherein a resistor in the series coupled resistance is electrically shorted by the dimming control signal to cause the LED driver to provide the low voltage output.

17. The step-dimming LED lighting system of claim 14, wherein the series coupled resistance comprises a second resistor coupled between a first and third resistor, and the dimming control module comprises dimming control leads coupled to each end of the second resistor.

18. The step-dimming LED lighting system of claim 10, wherein the LED module comprises a power supply to convert the constant output voltage to a constant current, and a low voltage protection circuit.

19. The step-dimming LED lighting system of claim 10, wherein the LED module comprises an LED bar.

20. The step-dimming LED lighting system of claim 10, wherein the constant output voltage from the LED driver is reduced by approximately one-half in the low output state.
